(19) United States
(12) Patent Application Publication
(10) Pub. No.: US 2005/0238533 A1
(43) Pub. Date: Oct. 27, 2005

(54) Refrigerant leak detector

(76) Inventor: Michael Jansen, San Antonio, TX (US)

Correspondence Address: WAYNE J COLTON INC;THE MILAM BUILDING SUITE 1032, 115 EAST TRAVIS STREET, SAN ANTONIO, TX, 78205, US

(21) Appl. No.: 10/865,477

(22) Filed: Jun. 10, 2004

Related U.S. Application Data
(60) Provisional application No. 60/553,228, filed on Mar. 15, 2004.

(51) Int. Cl. G01N 27/00

(52) U.S. Cl. 422/54

(57) ABSTRACT

A detector for indicating the presence of a refrigerant gas generally includes a source of flammable fluid, a burner having associated therewith a reaction element and a detector circuit. The burner is adapted to combust the flammable fluid to produce a flame about the reaction element while the detector circuit, which includes an optoelectronic color sensor in view of the flame, is adapted to signal the presence within the combusted fluid of a refrigerant gas. The indicator may be visual or audible. The burner may include a shield, which may serve to sink heat away from the sensor and/or to shield the flame from ambient breeze.

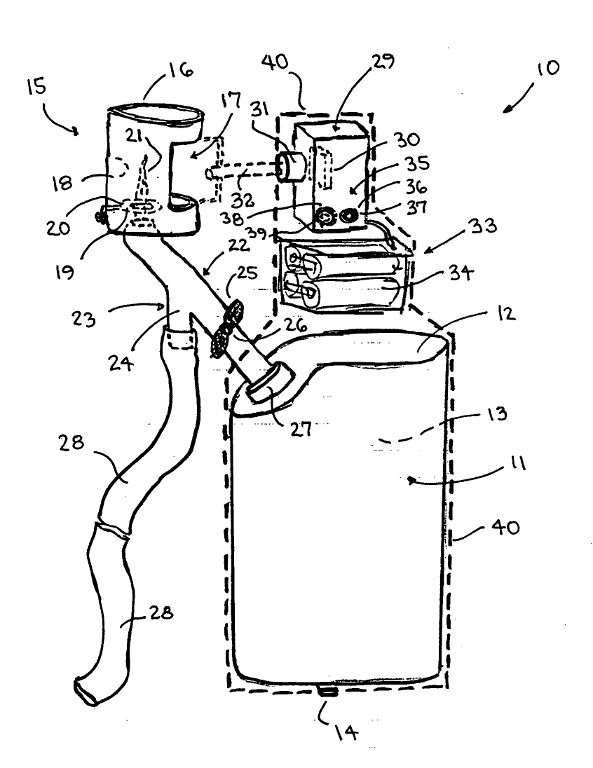

### REALTED APPLICATION

This application claims all available benefit, under 35 U.S.C. § 119(e), to copending U.S. provisional patent application Ser. No. 60/553,228 filed on Mar. 15, 2004. By this reference, the full disclosure of the U.S. provisional patent application Ser. No. 60/553,228 is incorporated herein as though now set forth in its entirety.

### FIELD OF THE INVENTION

The present invention relates to air conditioning and refrigeration maintenance. More particularly, the invention relates to a refrigerant leak detector with provision for the electronic determination and indication of the presence of a refrigerant gas.

### BACKGROUND OF THE INVENTION

Halide detectors operable by the passage of a leaked halide gas over a copper element in the presence of a flame have been known for over half a century. Unfortunately, notwithstanding their widespread use, the heretofore known apparatus all require the user to simultaneously observe the end of a hose placed in proximity of a suspected leak and a burner, which often must be located away from the area of the leak. As a result, it is often difficult for the user to accurately view the area of the leak or to do so without risk of inadvertent fire.

It is therefore an overriding object of the present invention to improve over the prior art by providing a halide leak detector which eliminates the need for the user to observe a flame. Additionally, it is an object of the present invention to provide such a leak detector which is economical to implement, easy to operate and generally safer than previously available detectors.

### SUMMARY OF THE INVENTION

In accordance with the foregoing objects, the present invention—a detector for indicating the presence of a refrigerant gas—generally comprises a source of flammable fluid, a burner having associated therewith a reaction element and a detector circuit. The burner is adapted to combust the flammable fluid to produce a flame about the reaction element while the detector circuit, which comprises an optoelectronic color sensor in view of the flame, is adapted to signal the presence within the combusted fluid of a refrigerant gas.

The indicator may comprise a visual output device such as, for example, a light emitting diode (“LED”) or other light source. Preferably, however, the indicator comprises an audible output device such as, for example, a piezoelectric buzzer. In this manner, the operator of the detector need only visually observe the area of the suspected leak, thereby the safety and efficiency with which the detection process may be accomplished.

The burner preferably comprises a shield, which may serve to sink heat away from the sensor and/or to shield the flame from ambient breeze. Additionally, the interior face of the shield may colored to produce contrast between the flame and the shield, thereby facilitating recognition by the sensor of the color of the flame.

In at least one embodiment, the detector comprises an optical waveguide between the shield and the sensor. As will be apparent to those of ordinary skill in the art, such a waveguide may be implemented with a fiber optic channel. Additionally, provision, such a specially adapted connection hardware, may be made for ensuring visibility by the sensor of the flame.

Finally, many other features, objects and advantages of the present invention will be apparent to those of ordinary skill in the relevant arts, especially in light of the foregoing discussions and the following drawings, exemplary detailed description and appended claims.

### BRIEF DESCRIPTION OF THE DRAWINGS

Although the scope of the present invention is much broader than any particular embodiment, a detailed description of the preferred embodiment follows together with illustrative figures, wherein like reference numerals refer to like components, and wherein the figure shows, in a perspective view, the preferred embodiment of the refrigerant leak detector of the present invention.

### DETAILED DESCRIPTION OF THE PREFERRED EMBODIMENT

Although those of ordinary skill in the art will readily recognize many alternative embodiments, especially in light of the illustrations provided herein, this detailed description is exemplary of the preferred embodiment of the present invention, the scope of which is limited only by the claims appended hereto.

Referring now to the figure, the refrigerant leak detector 10 of the present invention is shown to generally comprise a source of flammable fluid 11 in communication through a gas conduit 22 with a burner 15 and a detector circuit 29. As shown in the figure, the gas conduit 22 comprises a refrigerant inlet 23, such as a venturi 24, through which a leaked refrigerant may be injected into the gas flow from the source 11 to the burner 15. To this end, a detection hose 28 is preferably conventionally provided in connection with the refrigerant inlet 23.

As shown in the figure, the source of flammable fluid 11 may comprise a conventional tank 12 containing a compressed, flammable gas such as, for example, butane, propane or the like. For reasons that will be further understood further herein, it is also preferable to provide a refill port 14 in connection with the tank 12. In order to regulate the flow of flammable gas from the source of flammable fluid 11, the gas conduit 22 is preferably provided with a gas flow valve 25 such as, for example, a stopcock 26.

While many of the foregoing features of the refrigerant leak detector 10 of the present invention are typical of known halide leak detectors, the refrigerant leak detector 10 of the present invention further comprises a detector circuit 29 for automatically sensing the presence at the flame 21 produced within the burner 15 of a halide gas. In particular, the detector circuit 29 comprises an optoelectronic color sensor 30—an optoelectronic device well-known to those of ordinary skill in the art. As will be apparent to those of ordinary skill in the art, one such suitable optoelectronic color sensor is the trademark “TAOS” model TCS230 programmable color light-to-frequency converter commercially available from Texas Advanced Optoelectronic Solutions, Inc. of Plano, Tex. In the preferred embodiment of the present invention, the detector circuit also includes a lens 31 for directing the light from the flame 21 to the optoelectronic sensor 30. To this end, an optical waveguide 32 such as, for example, a fiber optic conduit may optionally be provided between the detector circuit 29 and the burner 15. In any case, the optoelectronic sensor 30 monitors the color of the flame 21, which, as with prior art detectors, is produced about a reaction element 19 such as, for example, a copper-containing ring 20 (for use in detecting halides) or a platinum-containing ring (for detecting HFC gases) or the like. The sensor 30 is thus adapted to detect the tell-tale color change in the flame 21 indicative of the intake through the hose 28 of a refrigerant gas.

The detector circuit 29 also includes an indicator 35 for alerting the user of the presence of a halide gas at the flame 21. While a visual output device 36 such as, for example, a light source 37, which may comprise a LED, may be utilized, the preferred embodiment of the indicator 35 comprises an audible output device 38 such as, for example, a piezoelectric buzzer 39. In this manner, the user may direct his/her attention to the distal end of the detection hose 28 rather than to observation of the visual output device 36. As a result, users of the present invention may more quickly and safely identify the location of leaking refrigerants.

Additionally, the burner 15 preferably comprises a shield 16, which may serve to sink heat away from the sensor 30 and/or to shield the flame 21 from ambient breeze. Additionally, the interior face 18 of the shield 16 may colored to produce contrast between the flame 21 and the shield 15, thereby facilitating recognition by the sensor 30 of the color of the flame 21.

While the foregoing description is exemplary of the preferred embodiment of the present invention, those of ordinary skill in the relevant arts will recognize the many variations, alterations, modifications, substitutions and the like as are readily possible, especially in light of this description, the accompanying drawings and claims drawn thereto. For example, those of ordinary skill in the art will recognize that it may be desirable to package the source 11, burner 15 and detector circuit 29 into an integral body 40, which may include its own battery pack 34 or other power source 33, in order to eliminate issues of alignment of the sensor 30 with the view port 17 through the shield 15. In the alternative, a self-orienting, quick-connect coupling 27 may be provided to facilitate proper alignment.

Additionally, those of ordinary skill in the art will recognize that the shield 16 may be nearly totally enclosed, for use in high light or strong wind conditions, in which case only an air inlet and exhaust need be provided. In this case, the provision of an optical waveguide 32 is particularly advantageous. Likewise, the shield may include fins or the like to facilitate radiation away from the detector 10 of heat.

Still further, those of ordinary skill in the art will recognize that the indicator 35 may take other forms such as, for example, the form of a vibrator or similar device. In any case, because the scope of the present invention is much broader than any particular embodiment, the foregoing detailed description should not be construed as a limitation of the scope of the present invention, which is limited only by the claims appended hereto.

1. A detector for indicating the presence of a refrigerant gas, said detector comprising:
a source of flammable fluid;
a burner having associated therewith a reaction element, said burner being adapted to produce, through combustion of said flammable fluid, a flame about said reaction element; and
a detector circuit, said detector circuit comprising:
an optoelectronic color sensor in view of said flame; and
an indicator for signaling the presence within the combusted fluid of a refrigerant gas.

2. The detector as recited in claim 1, wherein said indicator comprises a visual output device.

3. The detector as recited in claim 2, wherein said visual output device comprises a light source.

4. The detector as recited in claim 3, wherein said light source comprises a light emitting diode.

5. The detector as recited in claim 1, wherein said indicator comprises an audible output device.

6. The detector as recited in claim 5, wherein said audible output device comprises a piezoelectric buzzer.

7. The detector as recited in claim 5, wherein said burner comprises a shield.

8. The detector as recited in claim 7, wherein said shield is adapted to sink heat away from said sensor.

9. The detector as recited in claim 8, wherein said shield is further adapted to shield the flame from ambient breeze.

10. The detector as recited in claim 7, wherein the interior face of said shield is colored to facilitate recognition by said sensor of the color of said flame.

11. The detector as recited in claim 7, said detector further comprising an optical waveguide between said shield and said sensor.

12. The detector as recited in claim 11, wherein said waveguide comprises a fiber optic channel.

13. The detector as recited in claim 7, wherein:
said burner is in communication with said source through a gas conduit terminating in a quick-connect coupling; and
said coupling is adapted to place said shield in a desired orientation with respect to said sensor.

14. The detector as recited in claim 1, wherein said indicator comprises a vibrator.
